(19) United States
(12) Patent Application Publication
(10) Pub. No.: US 2007/0037629 A1
(43) Pub. Date: Feb. 15, 2007

(54) Configurable single platform mini golf course

(76) Inventors: Michael Renn Neal, Arvada, CO (US); Rianna Michele Neal, Arvada, CO (US)

Correspondence Address: Michael Renn Neal, 15747 W 74th Place, Arvada, CO, 80007, US

(21) Appl. No.: 11/202,396

(22) Filed: Aug. 12, 2005

(51) Int. Cl. G06F 17/00

(52) U.S. Cl. 473/157

(57) ABSTRACT

A method and apparatus are described that provide a mini golf course on a single, configurable platform comprised by at least one obstacle, hazard, hole position, tee position, manually placed add-ins, and a control panel. On one embodiment, a player uses the control panel to arrange a combination of options to provide a unique mini golf hole. A player may create one or more mini golf holes to comprise a complete mini golf game.

### BACKGROUND OF THE INVENTION

1. Field of the Invention

The present invention relates to a mini golf game. More particularly, the invention relates to utilizing a configurable platform to produce one or more different combinations of obstacles, hole positions, tee positions, and hazards comprising a mini golf course.

2. Description of the Related Art

There are many examples of related art where miniature putting greens are constructed to allow practice putting for the game of golf. There is also related art showing configuration of mini golf courses over large terrain areas. There are also portable putting green mechanisms to allow the transportation of golf game practice devices.

The act of putting on a practice green does not simulate the game of mini golf where navigating obstacles is one of the primary tests of the game.

For those who desire a mini golf course but do not have the terrain, area, or resources to create a typical nine or eighteen hole course, options are not available.

This invention supports the creation of varied holes on a single platform to allow players to experience a game similar to a large terrain, commercial game in a small amount of space which can be used either indoors or outdoors.

### SUMMARY OF THE INVENTION

The present invention provides a method for creating one or more golf holes on a single platform. In one embodiment, the platform is a 10 ft by 6 ft platform with a plurality of obstacles, hazards, hole positions, slope creation Slope Elevators, manually placed add-ins, and tee positions. The invention provides a challenging and changing game to one or more players.

The invention provides a control panel that allows a player to change the configuration of the golf hole into one or more configurations. In one embodiment, the control panel uses mechanical methods such as wire cable to expose, hide, or move one or more of the configurable components.

The invention provides a method to move hole locations to provide different challenges.

The invention provides a method to move tee locations to provide different challenges.

The invention provides multiple obstacle types to prevent direct access to hole locations providing a challenge that varies. In one embodiment, obstacle types include a rectangular obstacle which completely blocks access to parts of the putting surface area. In another embodiment, obstacle types include angles that allow players to hit their ball against the angle to navigate around other obstacles or hazards. In a third embodiment, an arc obstacle is provided to allow a player to hit a ball around another obstacle by putting into the arc. It is understood that another embodiment would contain one or all of the obstacle types on a single platform.

The invention provides hazards similar to a regulation golf course representing and imitating water hazards and sand traps. Various embodiments of the invention may contain one or more hazards on the platform. These hazards can be hidden by having a section of putting surface cover them or by having an obstacle block the ball's access to hazards.

The invention may provide one or more elevation rods or inflatables under the putting surface which raise a point on the putting surface to create a raised portion of the putting surface. A raised position of surface has the effect of causing a change in movement of the ball when it is putted on the raised area. In the game of golf, this ball movement is called a break and can add challenges to the game.

One embodiment or the present invention provides for the manual addition of add-ins to the course configuration. An example of an add-in is a piece of lawn art that can add challenge or fun to the game.

### BRIEF DESCRIPTION OF THE DRAWINGS

The appended claims set forth the features of the invention with particularity. The present invention is illustrated by way of example, and not by way of limitation, in the figures of the accompanying drawings in which like reference numerals refer to similar elements and in which:

FIG. 1 illustrates one embodiment of the invention;

FIG. 2a illustrates one embodiment of the control panel;

FIG. 2b illustrates another embodiment of the control panel;

FIG. 3 illustrates one embodiment of the mechanical mechanism to change hole positions;

FIG. 4 illustrates one embodiment of the mechanical mechanism to change tee positions;

FIG. 5 illustrates one embodiment of the mechanical mechanism to create different slopes;

FIG. 6 illustrates one embodiment of the pneumatic control to create different slopes;

FIG. 7 illustrates one embodiment of the mechanical mechanism to move obstacle locations;

FIG. 8 illustrates one embodiment of the mechanical mechanism to expose and cover hazards;

FIG. 9 illustrates one embodiment of the invention where players place objects onto the platform.

### DETAILED DESCRIPTION OF THE INVENTION

The present invention provides a single, configurable platform from which one or more mini golf holes can be constructed. A mini golf game involves one or more players hitting a ball with a club from a tee to a hole. The purpose of the game is to get the ball into the hole in as few hits as possible. There are many locations where people can visit and play a number of different mini golf holes. Typically, eighteen holes are used to form a complete mini golf course. These holes also typically contain a variety of obstacles, hazards, and slopes to make the holes challenging and interesting to players.

In the preferred embodiment, the configurable platform has a control panel which allows players to configure the single platform into configurations to provide a challenging and interesting game on a single platform. This allows players to play indoors or outdoors in a significantly smaller area than even two fixed golf holes could be constructed. A player controlled control panel uses mechanisms to enable the physical changing of the configurable components. A typical system consists of wires and pulleys to move the obstacles, cover and uncover hazards, raise and lower the elevation rod and move the hole location.

In one embodiment, the control panel utilizes pneumatic control to inflate and deflate elevators to create slope on the course.

The preferred embodiment does not preclude the players manually placing obstacles or add-ins such as a lawn ornament on the platform.

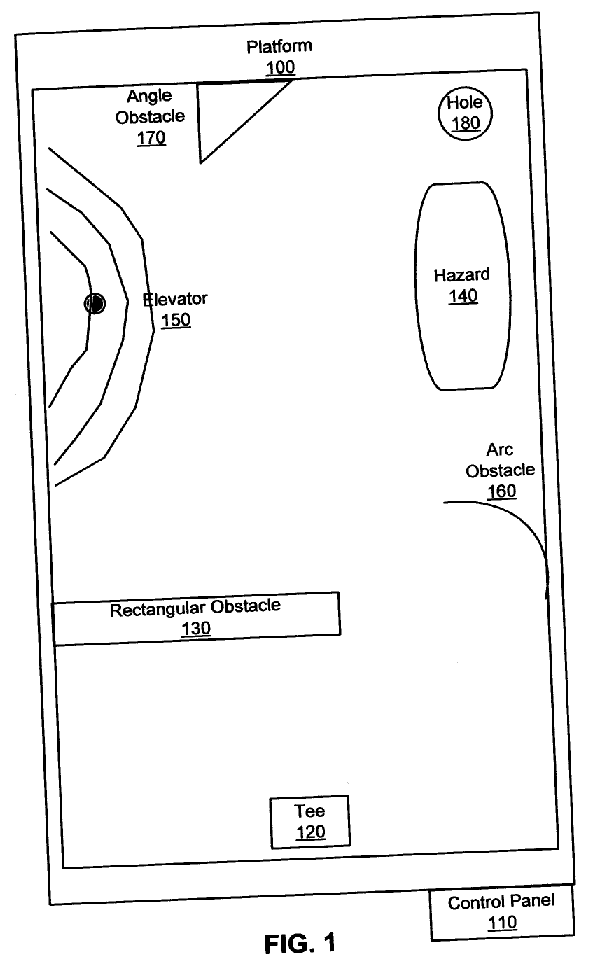

FIG. 1 shows a representative embodiment of the single platform system 100 for creation of a mini golf course. Players would choose their hole configuration by using controls on Control Panel 110. Control panel 110 uses a mechanism to move Tee 120 location from left to right. Control Panel 110 uses a mechanism to move Rectangular Obstacle 130 to the left or right to obstruct the path from the tee to the hole. The Control Panel 110 also provides a mechanism to drop the Rectangular Obstacle 130 to become level with the putting surface. The top of the obstacle is covered in the same material as the putting surface. Control Panel 110 uses a mechanism to raise and lower Slope Elevator Rod 150 to create a raised portion of the putting surface. Control Panel 110 uses a mechanism to move Arc Obstacle 160 along the side of Platform 100. The Arc Obstacle 160 can also be lowered into Platform 100 to provide a smooth putting surface. Control Panel 110 uses a mechanism to move Angle Obstacle 170 along the back wall of Platform 100. The Angle Obstacle 170 can also be lowered into Platform 100 to provide a smooth putting surface. Control Panel 110 uses a mechanism to move Hole 180 to one of several hole positions available.

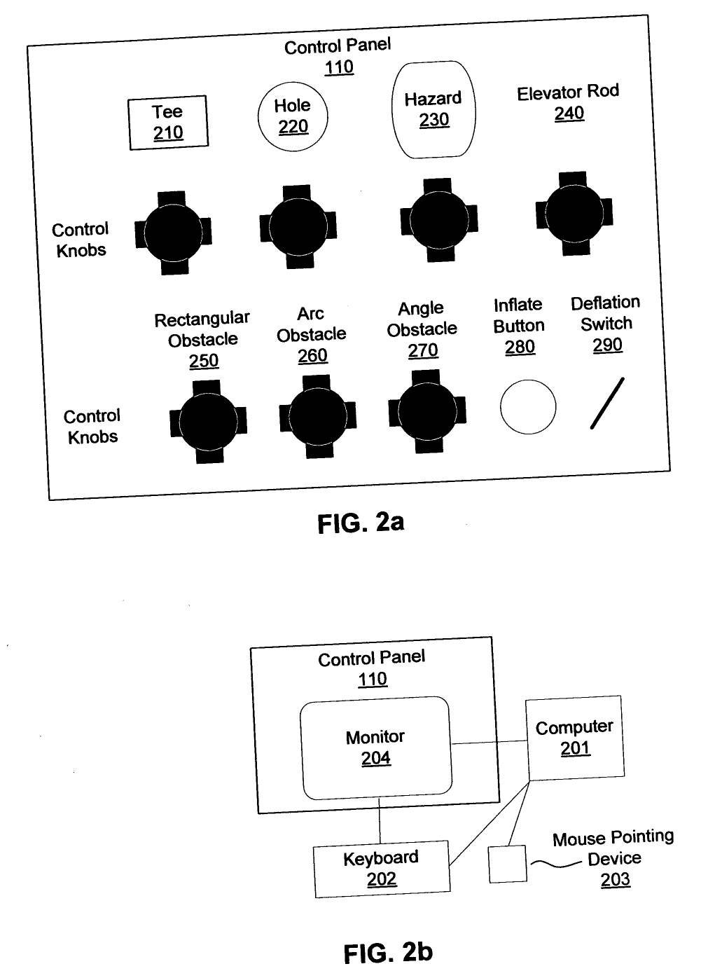

FIG. 2a shows one embodiment of the Control Panel 110. A series of individual control knobs are used to control the configuration components on the platform. The player turns Knob 210 to move the Tee location. The player turns Knob 220 to move the Hole location. The player turns Knob 230 to cover or uncover the Hazard. The player turns Knob 240 to move the Physical Slope Elevator. The player turns Knob 250 to move, raise, or lower the Rectangular Obstacle. The player turns Knob 260 to move, raise, or lower the Arc Obstacle. The player turns Knob 270 to move, raise, or lower the Angle Obstacle. The Inflate Button 280 increases the size of Inflatable Slope Elevator, and Deflation Switch 290 causes Slope Elevator to decrease in size.

FIG. 2b shows another embodiment of the Control Panel 110. The Control Panel is a Computer 201 which contains software programs to control the obstacles, tee position, hole position, and hazard. A player interacts with the computer through Keyboard 202 and Mouse Pointing Device 203. The player can create a new hole design or select from existing configurations on Monitor 204. The embodiment can also provide a Monitor 204 which has touch screen capability to allow player interaction with Computer 201.

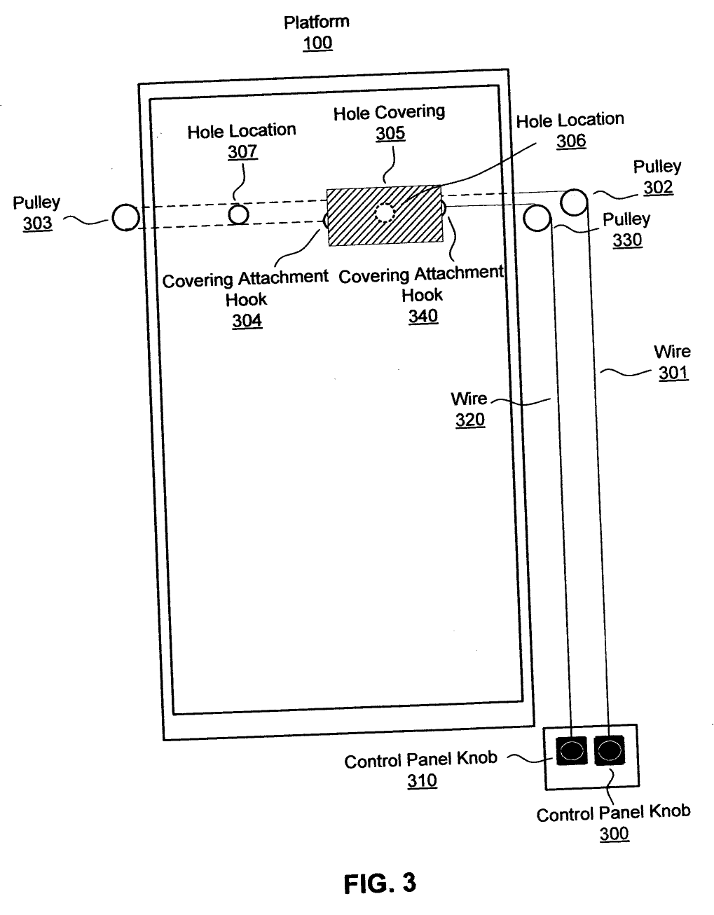

FIG. 3 illustrates how to change the hole position. To change the hole location on Platform 100, turn Control Panel Knob 300 which pulls Wire 301, wraps around Pulley 302, goes under Platform 100, wraps around Pulley 303, and returns under Platform 100 and connects to Covering Attachment Hook 304 which then pulls Hole Covering 305, uncovering Hole Location 306 and covering Hole Location 307. To adjust Platform 100's hole location to the original location, turn Control Panel Knob 310 which pulls Wire 320, wraps around Pulley 330, and attaches the Covering Attachment Hook 340, which then moves Hole Covering 305, covering Hole Location 306, and uncovering Hole Location 307.

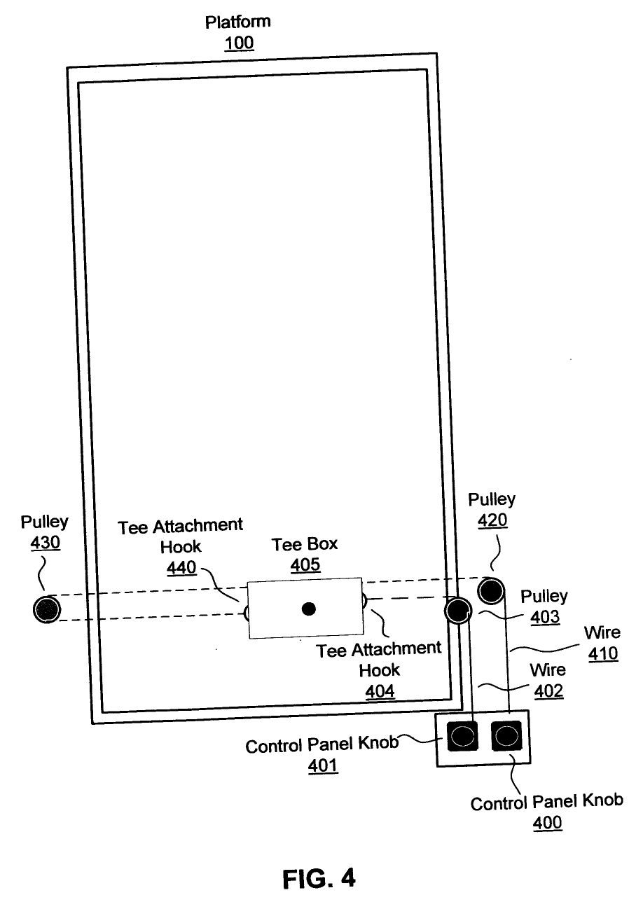

FIG. 4 illustrates how to change the tee location. To change the tee location on Platform 100, turn Control Panel Knob 401, which pulls Wire 402, wraps around Pulley 403 and attaches to Tee Attachment Hook 404 and moves Tee Box 405 to the right. To move the tee on Platform 100 to the left, turn Control Panel Knob 400 which pulls Wire 410, wraps around Pulley 420, goes under Platform 100, and wraps around Pulley 430, then returns under Platform 100, and attaches to Tee Attachment Hook 440, and moves Tee Box 405 to the left.

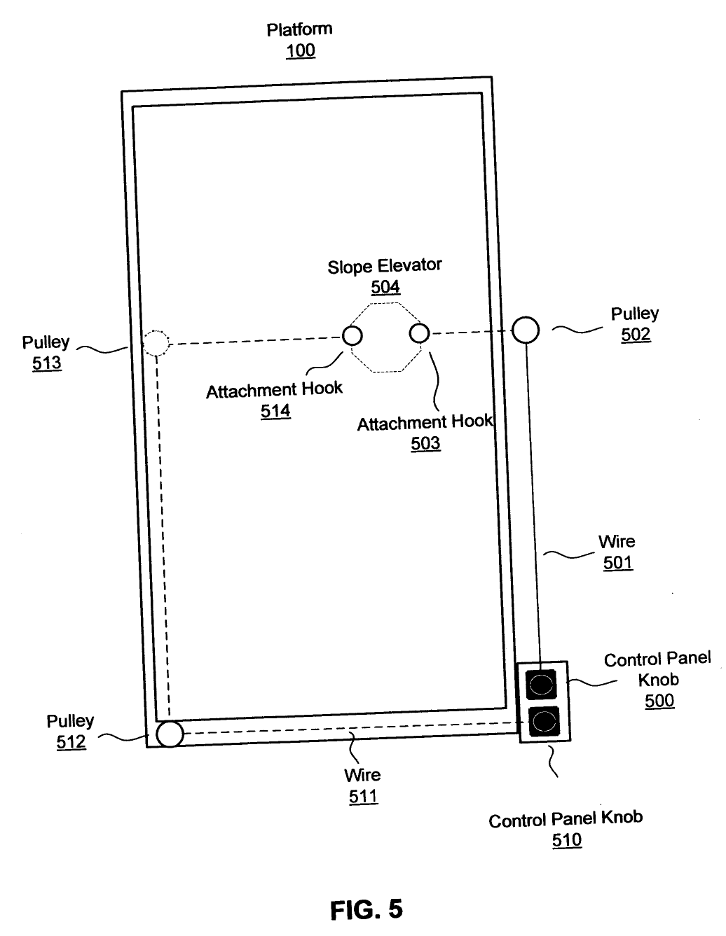

FIG. 5 illustrates how to create a slope on the right side of Platform 100. Turn Control Panel Knob 500 which pulls Wire 501, wraps around pulley 502, attaches to Attachment Hook 503 to move Slope Elevator 504. For this embodiment, the Slope Elevator is a ½″ high, six-sided, piece of wood immediately under the putting surface.

To create a slope on the left side of Platform 100, turn Control Panel Knob 510 which pulls Wire 511, wraps around Pulley 512 and Pulley 513 then attaches to Attachment Hook 514 to move Slope Elevator 504.

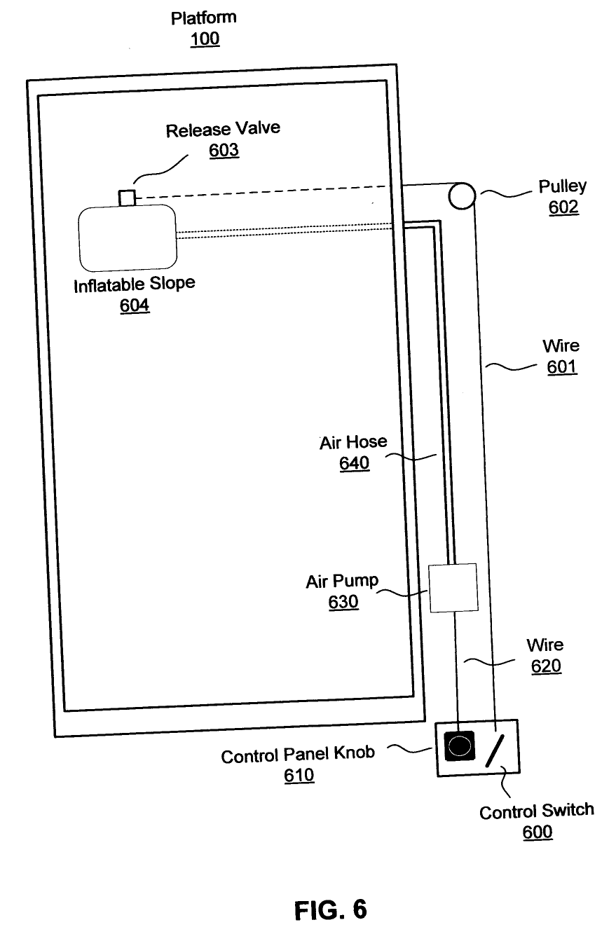

FIG. 6 illustrates another embodiment for slope creation. To deflate the Inflatable Slope 604 on Platform 100, turn Control Panel Knob 600, which pulls Wire 601, wraps around Pulley 602 and pulls Release Valve 603 to release air from Inflatable Slope 604. To re-inflate the Inflatable Slope 604 on Platform 100, turn Control Panel Knob 610 which pulls Wire 620 and activates Air Pump 630 which pumps air through Air Hose 640 and inflates Inflatable Slope 604.

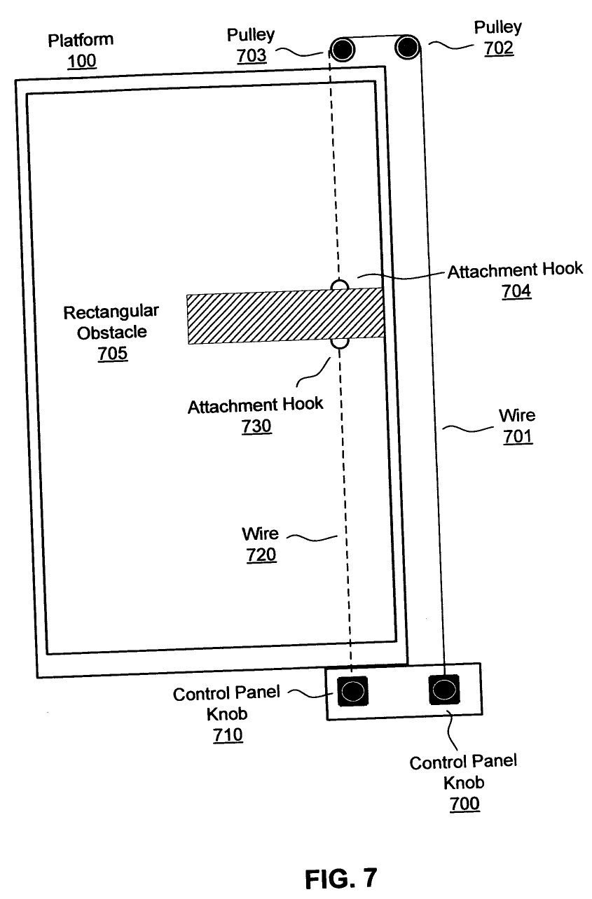

FIG. 7 illustrates how to move a representative obstacle. To move the Rectangular Obstacle 705 on platform 100 away from the tee box, turn Control Panel Knob 700, which pulls Wire 701, wraps around Pulley 702 and Pulley 703 and attaches to Attachment Hook 704 which pulls Rectangular Obstacle 705. To move the obstacle on Platform 100 closer to the tee box, turn Control Panel Knob 710 which pulls Wire 720 and attaches to Attachment Hook 730 and pulls Rectangular Obstacle 705.

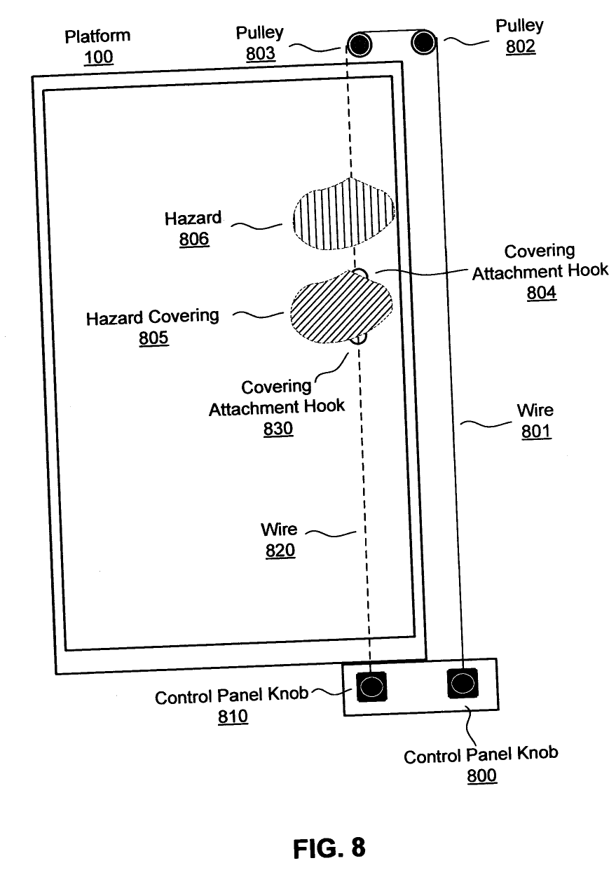

FIG. 8 illustrates how to expose and hide hazards. To cover the hazard on Platform 100, turn Control Panel Knob 800 which pulls Wire 801, wraps around Pulley 802 and Pulley 803 then attaches to Covering Attachment Hook 804 and pulls Hazard Covering 805 over Hazard 806. To recreate the hazard on Platform 100, turn Control Panel Knob 810 which pulls Wire 820 and attaches to Covering Attachment Hook 830 and pulls Hazard Covering 805 off of Hazard 806.

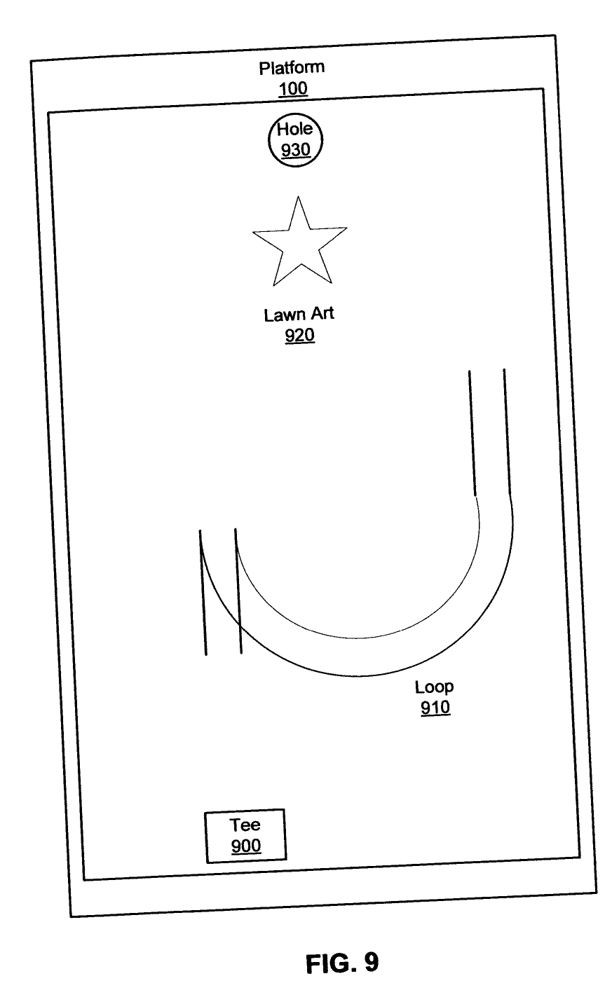

FIG. 9 illustrates other manually placed obstacles on Platform 100 which are called add-ons. As example, in FIG. 9, a player would putt the ball from Tee 900, up and around and down Loop 910, avoid Lawn Art 920, and putt the ball into Hole 930.

Although this disclosure describes illustrative embodiments of the invention in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

1. A method comprising:
A configurable platform,
providing a mechanism to configure one or more obstacles,
hazards, hole positions, or tee positions,
providing a mechanism to elevate none or part of the surface to create hills,
using a control panel,
to produce one or more holes of a mini golf course.

2. The method of claim 1, wherein control panel is a mechanical mechanism which adjusts a hole position with connected wires and pulleys.

3. The method of claim 1, wherein control panel is a mechanical mechanism which adjusts a tee position with connected wires and pulleys.

4. The method of claim 1, wherein control panel is a mechanical mechanism which covers or uncovers one or more hazards with a putting service with connected wires and pulleys.

5. The method of claim 1, wherein control panel is a mechanical mechanism which moves a shaped object under the putting surface connected wires and pulleys to create a slope.

6. The method of claim 1, wherein the system control panel activates a pneumatic control to inflate or deflate an air container under the putting surface to create a slope.

7. The method of claim 1, wherein the system control panel activates a pneumatic control to inflate or deflate air container under the putting surface to create a slope.

8. The method of claim 1, wherein a player places objects on the platform.

9. A method comprising:
A configurable platform,
providing a mechanism to configure one or more obstacles,
hazards, hole positions, or tee positions,
providing a mechanism to elevate none or part of the surface to create hills,
using an electronic control panel,
to produce one or more holes of a mini golf course.

10. The method of claim 9, wherein the electronic control panel is a computer system with software to operate the controls.

11. The method of claim 9 wherein the computer has software programs to create and save hole configurations.

12. The method of claim 9, wherein the interface to the electronic control panel is a keyboard and mouse pointing device.

13. The method of claim 9, wherein the interface device is a touch screen monitor.

14. The method of claim 9 where the software programs provides an interface to keep scores for the players.

15. The method of claim 9 where the software programs keep a history of scores and configurations.
